(19) United States
(12) Patent Application Publication
(10) Pub. No.: US 2004/0032489 A1
(43) Pub. Date: Feb. 19, 2004

(54) Method for displaying a visual element of a scene

(76) Inventor: Donald Wayne Tyra, Nashville, TN (US)

Correspondence Address: POWELL, GOLDSTEIN, FRAZER & MURPHY LLP, P.O. BOX 97223, WASHINGTON, DC, 20090-7223, US

(21) Appl. No.: 10/216,885

(22) Filed: Aug. 13, 2002

(51) Int. Cl. H04N 13/04

(52) U.S. Cl. 348/58; 348/59

(57) ABSTRACT

A method is provided for displaying a visual element of a scene within a stereoscopic image of the scene. The method may be used to plan, design or simulate the lighting of a music concert or theatrical performance. The scene is displayed as a stereoscopic image and all changes to the visual element are displayed in the stereoscopic image in real time. The method includes the steps of displaying a stereoscopic image of the scene, making changes to a visual element of the scene, and displaying the changes in the stereoscopic image in real time.

### FIELD OF THE INVENTION

The present invention generally relates to a method for designing and simulating visual elements for concerts, plays, performances, fashion shows, trade shows, television productions, movie productions, and sporting events. Changes made to visual elements such as lighting, scenic elements, and special effects are visible in real time within a stereoscopic image.

### BACKGROUND OF THE INVENTION

Traditionally, preparation for a live entertainment event has been time consuming and expensive. For example, preparation for a music concert often requires the visual elements of the event to be created and simulated in a full size set or live setting during the preproduction and rehearsal process. A production coordinator for the music concert must often rent an arena, rigging, staging, lighting, audio, video, and special effects equipment and hire the necessary personnel far in advance of the performance. Building this set includes transporting all of the required equipment into a venue, constructing a stage, assembling trusses to create a lighting rig, attaching and wiring lights, setting up other visual effects such as lasers, pyrotechnics, water effects, banners, scenery, props, and all audio equipment (speakers and instruments), and connecting and interfacing with all of the methods of control to create an accurate representation of the production. After building the set, a lighting designer will use a lighting console to program visual elements which will be used during the show. Visual elements such as lighting must be carefully designed to produce the effects that the artist desires. The lighting is often changed during this process to have the desired focus, color, intensity, movement, and beam size. The lighting can even be designed to coordinate with audio effects. This process is often complicated and can be delayed by weather conditions, manpower, scheduling conflicts, labor conflicts, limited set up time due to budget constraints, and equipment failure. Other common problems include an artist wishing to rehearse one small portion of a show repeatedly. In this case, the lighting designer must wait until the artist finishes to continue programming the rest of the show, thereby losing valuable time. To avoid some of these problems, designers often create and work from a crude representation of the venue as a planar image on paper or on a computer monitor. However, these images are not as accurate as a life size, physically tangible set. Therefore, many problems such as the inability to completely view the changes in real time and not providing true depth of elements in a scene are not solved. Frequently, large expensive effects like drop down banners are custom built, then not used because the designer discovers that the effect is blocking portions of the audience's view, rendering the effect unusable. Also, physical limitations of a venue can create problems so some previously planned visual effects cannot be used. For example, lights trusses or other effects may be planned to be positioned at a certain point when working with a drawing of the venue. However, the actual venue may make this impossible because of a physical obstruction that had not been previously known.

### OBJECT OF THE INVENTION

It is an object of the present invention to provide a method for building, viewing, programming, and controlling an accurate representation of a production without building a full size set or requiring travel to the venue, rental of the venue, rental of all the equipment, or paying the personnel required to build the production. It is another object of the present invention to provide an opportunity to view an animation of an event and, control and coordinate all visual elements before the event takes place.

It is another object of the present invention to electronically build an accurate and detailed model of any venue as a stereoscopic image and simulate visual effects of an event by utilizing a combination of custom software, high-speed hardware, and stereoscopic imaging technology. The modeling process can be performed quicker and with less expense than building the actual full size set. The modeling and programming of visual effects can occur at any convenient time prior to an event. Also, the electronic representation of a set or architectural parameters of a venue can be reused at any time for different events by different performers. The stereoscopic image provides true depth that is not possible with any planar image. Therefore, stereoscopic images are more aesthetically pleasing, more life-like, and more useful than planar images because they are true to scale and provide a more accurate visual representation. The images can be projected onto a large screen giving the lighting designer the true-to-life feeling of actually being in a full size venue. By using an electronic representation, a scene and its visual elements can be quickly and accurately manipulated. For example, a lighting designer can view the event from any angle and position that an audience member may view the event. The images can be combined to create an electronic rehearsal or virtual show. This electronic rehearsal can significantly reduce costs simply by minimizing the amount time that the venue and necessary equipment is rented. Changes to the overall design can be made quickly and easily with a few key strokes, rather than having to make the changes on site which would require additional manpower, time, and equipment. Therefore, expensive and time consuming problems are resolved prior to production and rehearsal.

### SUMMARY OF THE INVENTION

The present invention is generally directed towards a method of displaying a visual element of a scene comprising the steps of displaying a stereoscopic image of the scene, making changes to the visual element of the scene, and displaying the changes in the stereoscopic image in real time.

One embodiment of the present invention provides a method of displaying a visual element of a scene comprising the steps of creating a planar representation of the scene, using the representation to create a stereoscopic image of the scene, displaying the stereoscopic image of the scene, making a change to the visual element of the scene using an external hardware control device, and displaying the changes in the stereoscopic image in real time.

An alternate embodiment of the present invention provides a method of displaying a visual element of a scene comprising the steps of creating a planar representation of the scene using CAD software, using the representation to create a stereoscopic image of the venue, making a change to the visual element of the scene using an external hardware control device, displaying the change in the stereoscopic image in real time, and saving the change within the external hardware control device.

Another alternate embodiment provides a method of displaying a visual element of a concert venue comprising the steps of creating a planar representation of the concert venue using a CAD software system, using the representation to create a stereoscopic image of the concert venue, making a change to the visual element of the concert venue using an external hardware control device, displaying the change in the stereoscopic image in real time, and saving the change within the external hardware control device.

Other features, advantages, and objects of the present invention will become apparent to one with skill in the art upon examination of the detailed description. It is intended that all such features, advantages, and objects be included herein within the scope of the present invention.

### DETAILED DESCRIPTION OF THE PREFERRED EMBODIMENT

The present invention provides a novel method of viewing, designing, and simulating visual elements of a scene within a stereoscopic image. Visual elements can be anything that adds to the enjoyment or changes the representation or characterization of an object, venue, setting or presentation. Examples of visual elements which can be displayed and changed by the method of the present invention include lighting, laser effects, water effects, pyrotechnics, smoke, bubbles, fog, weather conditions, shadows, inanimate objects, people, staging, venues, background, scenic elements, audio equipment, and visual equipment. If lighting is to be displayed and changed, the method of the present invention allows one to easily make changes to the color, focus, hue, intensity, beam size, movement, aiming, positioning, and to the number of lighting fixtures. Other changes to lighting can also be made.

The method of the present invention allows one to quickly and accurately make changes to a scene. The scene can be any location, venue or setting. It can be a view of an architectural structure, object, animal or person. Examples of scenes include a music concert, theatrical performance, trade show, fashion show, sporting event, stage, arena, convention center, movie set, television set or presentation. The method of the present invention allows one to accurately plan, design, and simulate an entire musical or theatrical performance, television productions, movie production or sporting event with all visual elements viewable in a stereoscopic image.

A model of a scene may first be created as a planar image. The planar image can be in any media. For example, the planar image can be a photograph, drawing or computer image. The planar image can be based on the venue specifications, stage design or drawings of the venue. The modeling process can be executed using many different commercially available software such as a Computer Aided Design (CAD) software program. Examples of software that may be used are AutoCAD 2000 (available from Autodesk in Sydney, Australia), WYSIWIG (available from The CAST Group in Toronto, Canada), ShowDesigner (available from Martin in Denmark), and 3D Studio Max™ (available from Discreet in Montreal, Canada)

The planar representation of the scene may be used to create to a stereoscopic image. However, the stereoscopic image of the present invention can also be created without requiring a planar image to be created. The stereoscopic image can be created using ordinary desktop computer hardware or a computer work station. Computer software that may be used can be any software that is capable of creating stereoscopic images from planar images. Examples of computer software that may be used are modified versions of commercially available modeling programs such as WYSIWIG, ShowDesigner, and 3D Studio Max™. Software may also be used in unmodified form. One example of software that may be used in unmodified form is a proprietary stereoscopic visualizer by ESP Studios in Las Vegas, Nev. The computer may utilize a video card or graphics controller capable of decoding stereoscopic information. It is preferred to use a video card or graphics controller with a minimum of 64 megabytes of on board memory. Examples of video cards which may be used with the present invention are the Wildcat 3110 (available from 3D Labs in Milpitas, Calif.) and the Quadro™ 4 video card (available from NIVIDIA® in Santa Clara, Calif.). A series of these stereoscopic images viewed in quick succession can create a motion picture.

A stereoscopic image is an image which is commonly referred to as a three dimensional image. A stereoscopic image has two different perspectives. A viewer's left eye sees an image from one perspective and the right eye sees an image from a different perspective. The two images create a retinal disparity. This disparity creates a perception of depth. This effect can be accomplished by displaying two alternating sets of images on a monitor screen or by projecting the images onto a projector screen. Filters or optics can be used to direct the appropriate image to the appropriate eye.

Some stereoscopic displays require a viewer to wear special eyewear. Polarizing glasses (e.g., glasses with a polarizing film in each lens) are one example of eyewear that may be used. Polarizing glasses may be used with monitor displays or projection displays. In one example of a monitor display system, a liquid crystal film is placed over the surface of the monitor screen. This film is alternatively cycled between two different polarization orientations which correspond to the right and left lenses of the glasses worn by an observer. In one example of a projection display system, two projectors are used with a singe screen. Polarizing filters are placed over the lenses of each projector. Each filter corresponds to a lens of the glasses worn by an observer.

Other eyewear may utilize a liquid crystal display such as an electronic shutter which alternates blocking light to each of the left and right eyes. The view from the unobstructed eye corresponds to a specific view on a display. When the obstructed view is switched to the other eye, a different view is seen. The shuttering of the glasses is synchronized with the appropriate view on the display. The left eye sees only the view intended for the left eye, and the right eye sees only the view intended for the right eye. This shuttering takes place very rapidly and may occur over 100 times per second. Examples of preferred stereoscopic imaging systems which may be used in the present invention are the StereoEyes™ and CrystalEyes® products (available from StereoGraphics® Corporation in San Rafael, Calif.). A synchronized emitter sends an encoded wireless signal to the viewer's glasses, coordinating the shuttering of the glasses with the image viewed by each eye. The image can be viewed using any means which allows a viewer to see the image as a stereoscopic image. A larger image generally allows an observer to view a more detailed and more true to life image. A preferred viewing means of the present method is a monitor screen. The most preferred means is a large screen and a projector with a resolution of at least 1280×1024 pixels. An example of a projector that may be used is a Mirage 6000 (available from Christie Digital in Cypress, Calif.). Another example of a projector is the Galaxy (available from Barco in Xenia, Ohio).

One type of display that may be used with the method of the present invention is an autostereoscopic display. Autostereoscopic displays do not require the use of special glasses or other headgear. One type of autostereoscopic display is a lenticular display. This utilizes a series of hemi-cylindrical lenses aligned vertically so that light is refracted and directed to either the left or right eye of an observer depending on how the light beams are aimed onto the lens. This system can be used with a projector or a monitor. When used with a monitor system, horizontal pixels can be alternatively refracted in different directions to correspond with the left and right eye. When used with a projector system, two projectors are positioned at the rear of a screen, and project onto the lens on the front of the screen. Light is directed to the appropriate eye by the lens. It is possible for multiple observers to simultaneously view the stereoscopic image.

In another example of an autostereoscopic display, a liquid crystal display on the front of the monitor is used as a shutter and directs a view of an image to a specific eye. The shuttering takes place very rapidly to allow the perception of continuous movement and the gives the perception of true depth.

The visual elements of a scene can be controlled and changed by any method or device which would allow one to make the desired changes. In a preferred embodiment of the present invention, an external hardware control device is used. Changes which are made to the visual elements are viewable in real time, as they are made with the external hardware control device. In a preferred embodiment, the external hardware control device is a commercially available lighting console. Lighting consoles are used to control lighting parameters such as color, intensity, beam shape, movement, speed, aiming, positioning, and focus. Examples of lighting consoles which may be used with the method of the present invention include, but are not limited to the Wholehog II (available from Flying Pig Systems in London, England), the grandMA (available from MA Lighting in Waldbuettelbrunn, Germany), the Icon® desk (available from LSD/Fourth Phase in Newbury Park, Calif.), the Insight® (available from Electronic Theatre Controls in Middleton, Wis.), and the Maxxyz (available from Martin in Aarhus, Denmark). Other examples of lighting consoles include the Sapphire, Pearl, and Emerald which are all manufactured by Avolites Ltd. (located in London, England).

Lighting consoles have programming and memory functions and can operate in a very similar manner to computer systems. Once changes to visual elements such as lighting are finalized, they can be saved in the lighting console's memory, at a remote location or in a portable memory storage device. This memory storage can be in any storage medium. In the preferred embodiments, the storage mediums are a portable floppy disk or a small capacity hard drive. The stored information can be used to play back the images and visual elements to simulate a concert or event. In the most preferred embodiment, the information is also used to coordinate with the full scale lighting and visual effects which are used during a production or live performance. The visual elements are played back during an actual production or live performance.

In a preferred embodiment of the present invention, a computer system with at least two processors of at least 2.0 gigahertz capacity each is used. The computer system also has at least 1 gigabyte of RAM and at least 20 gigabytes of data storage space. The computer also utilizes a video card or graphics controller with a minimum of 64 megabytes of on board memory capable of decoding stereoscopic information. The equipment which runs the stereoscopic display includes at least one high powered RF stereoscopic emitter and several pairs of StereoEyes™ shutter glasses. The image that is viewed is projected onto a screen using a projector that is capable of running at a refresh rate of at least 120 cycles per second. This allows the projection of two simultaneous images that are required to display the stereoscopic image. The projector is one that is capable of displaying a resolution of at least 1280×1024 pixels.

The present invention is illustrated by the following examples that should not be considered limiting.

### EXAMPLE 1

A planar image of an existing venue for a rock music concert is constructed using 3D Studio Max™ and a Dell P530 desktop computer with dual 2.2 gigahertz processors, 1 gigabyte of RAM, 40 gigabytes of data storage, and a Wildcat 3110 video card. Data describing this image is transferred into a modified version of ShowDesigner which uses the information to create a stereoscopic image of the concert venue. The stereoscopic image is sent to the video card, which routes the display signal to a projector. The projector that is used is a Mirage 6000 and it projects the light onto a screen which is 30 feet by 20 feet. The video card also sends data to emitters, which broadcast the signal to control shutter glasses. The glasses that are used are StereoEyes™. A Flying Pig Whole Hogg II lighting console is used to make changes to the lighting of the concert venue.

Changes are made to the color, positioning, and movement of lights which are directed on various areas of the venue while simultaneously viewing the venue and lighting. No changes are made to fixtures in the scene. The movement of the light beams are coordinated with music which will be played during the concert. The lighting changes are seen as they are made using the lighting console. The lighting (including the movement) and music can also be played back repeatedly to see a preview of the live concert. Further changes may be made to the lighting at anytime during this process. The final changes are stored on a floppy disk and will be used later, during the live concert performance.

### EXAMPLE 2

A planar image of an trade show exhibit is constructed using WYSIWIG and a Sun Graphics International work station with dual 2.2 gigahertz processors, 1 gigabyte of RAM, 40 gigabytes of data storage, and a Quadro™ 4 video card. Data describing this image is transferred into a modified version of WYSIWIG which uses the information to create a stereoscopic image of the exhibit area. The stereoscopic image is sent to the video card, which routes the display signal to a projector. The projector that is used is a Galaxy projector and it projects the light onto a screen which is 30 feet by 20 feet. The video card also sends data to emitters, which broadcast the signal to control shutter glasses. The glasses that are used are CyrstalEyes™. A Maxxyz lighting console is used to make changes to the lighting of the exhibit area.

Changes are made to the color, beam shape, positioning, and number of lights which are directed on various areas of the exhibit while simultaneously viewing the exhibit and lighting. No changes are made to the fixtures. The lighting changes are seen as they are made using the lighting console. The final changes are stored on a hard drive. Later, the lighting console with the hard drive are taken to the exhibit hall for the trade show. The final lighting changes which are stored on the hard drive are played back for the event.

### EXAMPLE 3

A planar image of an existing venue for a music concert is constructed using AutoCAD 2000 and a Hewlett-Packard work station with dual 2.2 gigahertz processors, 1 gigabyte of RAM, 40 gigabytes of data storage, and a Wildcat 3110 video card. Data describing this image is transferred into a modified version of ShowDesigner which uses the information to create a stereoscopic image of the concert venue. The stereoscopic image is sent to the video card, which routes the display signal to a projector. The projector that is used is a Mirage 6000 and it projects the light onto a screen which is 30 feet by 20 feet. The video card also sends data to emitters, which broadcast the signal to control shutter glasses. The glasses that are used are StereoEyes™. An Insight® lighting console is used to make changes to the lighting of the concert venue.

Changes are made to the timing of when lights are turned on and off, their color, intensity, positioning, and movement of lights which are directed on various areas of the venue while simultaneously viewing the venue and lighting. The background scenery is also changed. The changes are viewable in real time. The image is rotated so the venue can be viewed from different perspectives. This allows a lighting designer the ability to see a view of the venue from any seat in the audience. The movement and flashing of the light beams are coordinated with music. The final lighting changes will be played during the concert. The lighting changes are seen as they are made using the lighting console. The lighting (including the movement) and music can also be played back repeatedly to see a preview of the live concert. Further changes may be made to the lighting at anytime during this process. The final changes are stored on a floppy disk and will be used later, during the live concert performance.

It should be emphasized that the foregoing description has been presented for purpose of providing a clear understanding of the invention. The description is not intended to be exhaustive or to limit the invention to the precise examples disclosed. Obvious modifications or variations by one with skill in the art are possible in light of the above teachings without departing from the spirit and principles of the invention. All such modifications and variations are intended to be within the scope of the present invention and protected by the following claims.

What is claimed is:

1. A method of displaying a visual element of a scene comprising the steps of
displaying a stereoscopic image of said scene,
making a change to said visual element of said scene, and
displaying said change in said stereoscopic image in real time.

2. The method of claim 1, wherein said scene is a venue for a theatrical performance.

3. The method of claim 1, wherein said scene is trade show.

4. The method of claim 1, wherein said scene is architectural structure.

5. The method of claim 1, wherein said scene is a venue for a sporting event.

6. The method of claim 1, wherein said stereoscopic image is displayed using a projector.

7. The method of claim 1, wherein said stereoscopic image is displayed using a monitor screen.

8. The method of claim 1, wherein said stereoscopic image is viewed using polarizing glasses.

9. The method of claim 1, wherein said stereoscopic image is viewed using electronic stereo glasses and a synchronized emitter.

10. The method of claim 1, wherein said stereoscopic image is displayed using an autostereoscopic display.

11. The method of claim 1, wherein said stereoscopic image is displayed using a lenticular display.

12. A method of displaying a visual element of a scene comprising the steps of
creating a planar representation of said scene,
using said representation to create a stereoscopic image of said scene,
displaying said stereoscopic image of said scene,
making a change to said visual element of said scene using an external hardware control device, and
displaying said change in said stereoscopic image in real time.

13. A method of displaying a visual element of a scene comprising the steps of
creating a planar representation of said scene using CAD software,
using said representation to create a stereoscopic image of said scene,
making a change to said visual element of said scene using an external hardware control device,
displaying said change in said stereoscopic image in real time, and
saving said change in said external hardware control device.

14. A method of displaying a visual element of a concert venue comprising the steps of
displaying a stereoscopic image of said concert venue,
making a change to said visual element of said concert venue, and
displaying said change in said stereoscopic image in real time.

15. A method of displaying a visual element of a concert venue comprising the steps of
creating a planar representation of said concert venue using a CAD software,
using said representation to create a stereoscopic image of said scene,
making a change to said visual element of said scene using an external hardware control device,
displaying said change in said stereoscopic image in real time, and
saving said change in said external hardware control device.

16. The method of claim 15, wherein said stereoscopic image is displayed using a projector.

17. The method of claim 15, wherein said stereoscopic image is displayed using a monitor screen.

18. The method of claim 15, wherein said stereoscopic image is viewed using polarizing glasses.

19. The method of claim 15, wherein said stereoscopic image is viewed using electronic stereo glasses and a synchronized emitter.

20. The method of claim 15, wherein said stereoscopic image is displayed using an autostereoscopic display.

21. The stereoscopic image produced by the method of any one of claims 1-20.

22. The external hardware control device of any one of claims 12, 13 or 15-20

23. The method of claim 12, further comprising saving said change on a storage medium.

24. The storage medium of claim 23.

25. The method of claim 14, further comprising saving said change on a storage medium.

26. The storage medium of claim 25.
